(19) United States
(12) Patent Application Publication
(10) Pub. No.: US 2025/0059074 A1
(43) Pub. Date: Feb. 20, 2025

(54) ANTIMICROBIAL SYSTEM AND METHOD

(71) Applicant: KEMIRA OYJ, HELSINKI (FI)

(72) Inventors: Jaakko SIMELL, Espoo (FI); Marko KOLARI, Espoo (FI)

(21) Appl. No.: 18/722,158

(22) PCT Filed: Dec. 20, 2022
(86) PCT No.: PCT/EP2022/087035

§ 371 Date: Jun. 20, 2024

(30) Foreign Application Priority Data
Dec. 21, 2021 (GB) 2118669.7

(51) Int. Cl. C02F 1/76; A01N 41/10; A01N 59/00; C02F 1/50; C02F 103/02

(52) U.S. Cl. CPC C02F 1/76; A01N 41/10; A01N 59/00; C02F 1/50; C02F 2103/023; C02F 2303/20; C02F 2307/14

(57) ABSTRACT

An antimicrobial system comprising: (a) an antimicrobial compound according to Formula I and (b) an inorganic source of hypochlorite, wherein the antimicrobial compound and the inorganic source of hypochlorite are separate components or comprise a unitary composition; wherein R1, R2 and R3 independently represent a hydrogen atom; halogen atom; hydroxy group; amino group; alkylamino group, alkyl group, hydroxyalkyl group, acyl group, haloalkyl group or alkoxy group having 1 to 4 carbon atoms; or an acylamido group having 1 to 10 carbon atoms; and A represents 2-thiazolamine; 2-propenenitrile; 2-propenoic acid; alkyl ester or hydroxyalkyl ester of 2-propenoic acid having 1 to 4 carbon atoms; or —CHCHCONR5R6 group, where R5 and R6 represent independently hydrogen atom, alkyl or hydroxyalkyl having 1 to 4 carbon atoms. The antimicrobial compound and the inorganic source of hypochlorite may be used separately, sequentially or simultaneously.

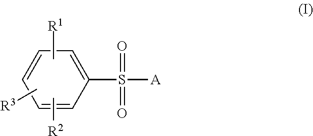

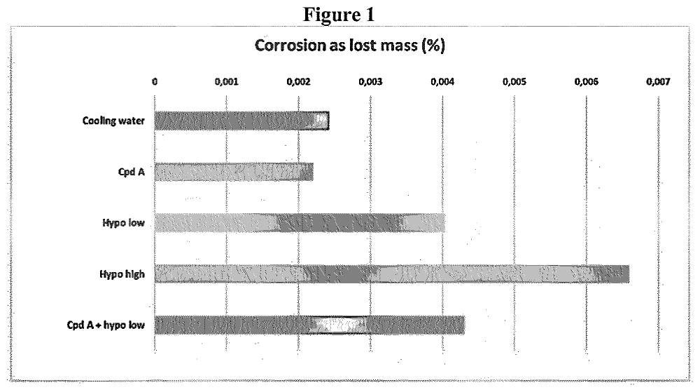

The present invention relates to a method for treating industrial cooling water, methods for reducing or preventing growth of microorganisms such as bacteria, and systems and compositions therefor.

### BACKGROUND TO THE INVENTION

Microorganisms such as bacteria can present a problem when apparatus or machinery comes into contact with aqueous systems. Bacteria in water can exist in a free-floating form (sometimes known as planktonic) or can be in the form of a biofilm associated with surfaces. Biofilms in particular can be difficult to remove because they contain not only bacterial mass but also a protective sheath or film formed by the bacteria.

High levels of bacterial growth can be very problematic in industrial processes. Industrial cooling water is used in cooling systems to transfer heat from one region of an industrial process to another or to the outside, for example using an industrial cooling tower. In many configurations, the cooling water is recirculated within the system. Industrial cooling water is susceptible to bacterial growth problems particularly because these systems are operated for long periods at temperatures enabling microorganisms to flourish. If left untreated, biofilm growth on surfaces will reduce conductive heat transfer across surfaces and reduce performance of the cooling system, and therefore regular downtime for cleaning is required. It is therefore desirable to control microbe problems and this has been achieved by adding biocidal materials to the cooling waters.

Halogenated compounds have been shown to be effective biocides. Haloamines, hypochlorites and chlorine dioxide are effective chemicals for microbe control on account of their ability to oxidize components of bacterial cells. They are relatively inexpensive and, at sufficiently high concentrations, can minimise both planktonic bacterial levels and prevent biofilm slime formation on system surfaces.

Although these biocides are effective, the presence of active halogen such as chlorine has been found to give rise to corrosion problems on metal and concrete surfaces. These problems may arise in cooling water systems on fully immersed surfaces, or on surfaces in the gas phase or at the interface of the water and gas phase. For example, mild steel is commonly found in cooling water systems and is highly susceptible to corrosion. A cooling tower is particularly susceptible to corrosion where metal surfaces are exposed to both liquid and gas phase chemicals.

A common measure to reduce the problem of corrosion is to deploy corrosion inhibitor chemicals in cooling water systems. Such inhibitors can be very expensive.

Another measure proposed to reduce the problem of corrosion is presented in EP2297046. Here, halogenated hydantoins were used in combination with haloamines. However, halogenated hydantoins are also expensive and contain themselves active halogen which can still contribute to the problems of corrosion.

EP009392 has proposed the compound 3-[(4-methylphenyl)sulphonyl]-2-propenenitrile for controlling the growth of algae in ponds, lakes and other areas in which industrial process water is stored. The algicidal effect is ascribed to an inhibition of photosynthesis. This requires high levels of the compound, which would make it very expensive to use.

There therefore remains a need to provide effective control of microorganisms in industrial cooling water systems whilst simultaneously minimising the problems of corrosion.

### SUMMARY OF THE INVENTION

In a first aspect, the present invention provides an antimicrobial system comprising: (a) an antimicrobial compound according to Formula I

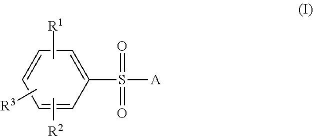

and
   (b) an inorganic source of hypochlorite,
wherein the antimicrobial compound and the inorganic source of hypochlorite are separate components or comprise a unitary composition;
wherein R1, R2 and R3 independently represent a hydrogen atom; halogen atom; hydroxy group; amino group; alkylamino group, alkyl group, hydroxyalkyl group, acyl group, haloalkyl group or alkoxy group having 1 to 4 carbon atoms; or an acylamido group having 1 to 10 carbon atoms; and
A represents 2-thiazolamine; 2-propenenitrile; 2-propenoic acid; alkyl ester or hydroxyalkyl ester of 2-propenoic acid having 1 to 4 carbon atoms; or —CHCHCONR5R6 group, where R5and R6 represent independently hydrogen atom, alkyl or hydroxyalkyl having 1 to 4 carbon atoms. The antimicrobial compound and the inorganic source of hypochlorite may be used separately, sequentially or simultaneously.

In a second aspect, the present invention provides a method for treating industrial cooling water, which method comprises administering to the water (i) an amount of an antimicrobial compound according to Formula I

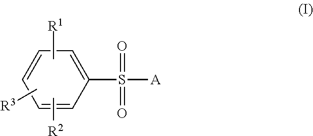

and
(ii) an amount of an inorganic source of hypochlorite;
wherein R1, R2 and R3 independently represent a hydrogen atom; halogen atom; hydroxy group; amino group; alkylamino group, alkyl group, hydroxyalkyl group, acyl group, haloalkyl group or alkoxy group having 1 to 4 carbon atoms; or an acylamido group having 1 to 10 carbon atoms; and
A represents 2-thiazolamine; 2-propenenitrile; 2-propenoic acid; alkyl ester or hydroxyalkyl ester of 2-propenoic acid having 1 to 4 carbon atoms; or —CHCHCONR5R6 group, where R5 and R6 represent independently hydrogen atom, alkyl or hydroxyalkyl having 1 to 4 carbon atoms. The antimicrobial compound and the inorganic source of hypochlorite may be administered separately, sequentially or simultaneously. They may be administered to the water at the same location or at different locations.

In accordance with the method for treating industrial cooling water, growth of microorganisms such as bacteria may be reduced or prevented. Such growth may be growth of free, planktonic microorganisms or those present in a structure such as a biofilm. This may arise by killing pre-existing microorganisms or stopping growth of new microorganisms. In this way, biofilm formation may also be reduced or prevented and pre-existing, formed biofilm may be reduced or removed, for example by dissolution of biofilm so that the microorganisms become planktonic and are subsequently killed.

It has surprisingly been found that a combination of the antimicrobial compound and the inorganic source of hypochlorite according to the invention provides effective activity against biofilms while simultaneously using only a low amount of hypochlorite. This means that, in use with cooling water equipment, the antimicrobial system produces reduced corrosion because less active chlorine is required. A safer working environment is also provided by the lower active chlorine use in production. Also risk is reduced for formation of chlorinated disinfection by-products which is an environmental benefit. Expensive deployment of corrosion inhibitor chemicals is reduced or avoided.

Without wishing to be bound by theory, it is thought that the presence of the antimicrobial compound prevents biofilm formation and promotes biofilm dissolution. The inorganic source of hypochlorite is particularly effective against planktonic microorganisms even at low concentrations of hypochlorite. Higher concentrations of the inorganic source of hypochlorite previously required to be effective against biofilms are not needed in the presence of the antimicrobial compound.

The antimicrobial compound has the structural Formula I. In this Formula, R1, R2 and R3 are independently substituents on the benzene ring at the ortho, meta and para positions.

Advantageously, R1 represents a methyl group; ethyl group; propyl group; butyl group; methoxy group; ethoxy group; propoxy group; isopropoxy group; n-butoxy group; or tertiary butoxy group; and/or
R2 and R3 represent independently hydrogen atom; methyl group; ethyl group; propyl group; butyl group; methoxy group; ethoxy group; propoxy group; isopropoxy group; n-butoxy group; tertiary butoxy group; and/or
A represents 2-propenenitrile.

Alternatively, R1 represents methyl group; ethyl group; propyl group; butyl group; methoxy group; ethoxy group; propoxy group; isopropoxy group; n-butoxy group; tertiary butoxy group; or amino group; and/or
R2 and R3 represent independently hydrogen atom; methyl group; ethyl group; propyl group; butyl group; methoxy group; ethoxy group; propoxy group; isopropoxy group; n-butoxy group; tertiary butoxy group; and/or
A represents a —CHCHCONR5R6 group, where R5 and R6 represent independently hydrogen atom; alkyl or hydroxyalkyl having 1 to 4 carbon atoms; preferably R5 and R6 representing hydrogen atoms.

Preferably, the compound according to Formula I is selected from the group consisting of 3-[(4-methylphenyl)sulphonyl]-2-propenenitrile, 3-phenylsulphonyl-2-propenenitrile, 3-[(4-fluorophenyl)sulphonyl]-2-propenenitrile, 3-[(4-trifluormethylphenyl)sulphonyl]-2-propenenitrile, 3-[(2,4-dimethylphenyl)sulphonyl]-2-propenenitrile, 3-[(3,4-dimethylphenyl)sulphonyl]2-propenenitrile, 3-(3,5-dimethylphenyl)sulphonyl-2-propenenitrile, 3-[(2,4, 6-trimethylphenyl)sulphonyl]-2-propenenitrile, 3-(4-methoxyphenyl)sulphonyl-2-propenenitrile, 3-[(4-methylphenyl)sulphonyl]prop-2-enamide, 3-[(4-methylphenyl)sulphonyl]prop-2-enoic acid, and any of their isomers. Of these compounds it is more preferred that the compound according to Formula I is selected from the group consisting of 3-[(4-methylphenyl)sulphonyl]-2-propenenitrile, 3-phenylsulphonyl-2-propenenitrile, 3-[(4-trifluormethylphenyl)sulphonyl]-2-propenenitrile, 3-[(2,4,6-trimethylphenyl)sulphonyl]-2-propenenitrile, 3-(4-methoxyphenyl)sulphonyl-2-propenenitrile and 3-[(4-methylphenyl)sulphonyl]prop-2-enamide; and any of their isomers. It is particularly preferred that the compound is 3-[(4-methylphenyl)sulphonyl]-2-propenenitrile.

Antimicrobial compounds suitable for use in the present invention and their synthesis are also described in WO2019/042984A and WO2019/042985A.

The inorganic source of hypochlorite may comprise a hypochlorite salt of an alkali metal or alkaline earth metal, of which typical examples include sodium hypochlorite and calcium hypochlorite. Sodium hypochlorite is inexpensive, readily available, and is generally provided as an aqueous solution, typically at 10 to 15 wt %. Sodium hypochlorite solutions have limited storage stability. They decompose over time, and decomposition is accelerated by elevation in temperature and reduction in pH. It is therefore preferred that such solutions are sourced from a manufacturing facility with short delivery times and used quickly. It is also possible to provide sodium hypochlorite solutions by on-site generation, for example by electrolysis of aqueous sodium chloride. This can be even less expensive than sourcing the sodium hypochlorite externally.

Another commercially available source of inorganic hypochlorite is calcium hypochlorite. Calcium hypochlorite is manufactured as a solid which is relatively stable. This makes it easier to transport and store. The solid is highly soluble in water for dosing at the point of use. However, calcium hypochlorite is much more expensive than sodium hypochlorite.

A particularly useful combination of antimicrobial compound and inorganic source of hypochlorite is 3-[(4-methylphenyl)sulphonyl]-2-propenenitrile and sodium hypochlorite.

The method of the invention is applicable to a variety of industrial cooling water systems. These systems operate at a wide range of temperatures depending on the temperature of the water supply and the temperature at which the industrial process or apparatus to be cooled. Temperatures in the range 5° C. to 50° C. or more are found. Many such systems operate at elevated temperature, such as at least 30° C., at least 40° C. or at least 50° C.

The growth of microorganisms is found at all temperatures with many thriving at elevated temperatures. Typical microorganisms, particularly bacteria found in industrial cooling water include those from the phylum Proteobacteria such as, Pseudoxanthomonas. These bacteria thrive at elevated temperature. Other microorgansims include Alphaproteobacteria (Aliihoeflea, Bosea, Brevundimonas, Devosia, Erythrobacter, Hyphomicrobium, Methylobacterium, Paracoccus, Porphyrobacter, Sphingomonas, Sphingopyxis parvularcula, Rhodobacter, Roscococcus, Rubellimicrobium), Betaproteobacteria, (Cupriavidus, Delftia, Hydrogenophaga, Massilia, Rubrivivax), Cyanobacteria (Aphanothece, Brasilonema, Calothrix, Chroococcidiopsistermalis, Chroococcus, Cyanobium, Cyanothece, Cyanosarcina, Geitlerinema, Glococapsa, Glococapsopsis, Glocothece, Hassallia, Leptolyngbya, Merismopedia, Microcoleus, Nodularia, Nostoc, Phormidium, Pleurocapsa, Pseudanabaena, Scytonema, Symploca, Tolypothrix), Gammaproteobacteria, (Acinetobacter, Erwinia, Pseudoxanthomonas, Rhizobacter), Firmicutes (Clostridium, Exiguobacterium), Actinobacteria (Microbacterium, Microcella, Serinicoccus), Plantomycetes, Acidobacteria, Bacteroidetes (Arenibacter, Flavobacterium, Flexibacter), Diatoms (Achnanhes, Amphora, Cymbella, Diadesmis, Gomphonema, Navicula, Nitzschia, Pinnularia, Surirella), Green algae (Cladophora, Chlorella, Cosmarium, Glococystis, Monodopsis, Pseudococcomyxa, Scenedesmus, Stigcoclonium, Ulothrix, Vischeria), and Fungi (Aspergillus, Penicillium).

In one aspect, the antimicrobial system of the invention is added to cooling water systems which are generally in a separate circuit from the industrial process or apparatus subjected to the cooling. Cooling water systems are used with a wide variety of different industrial processes, including manufacturing processes such as those comprising fibre material for the manufacture of paper, board or pulp, as well as apparatus in chemical plants, oil refineries, power stations, mining sites, steel mills and other industrial installations. These cooling water systems can vary significantly in design. Typically, such cooling water systems comprise circulating water which contacts with a heat exchanger that is in contact with heated process water or apparatus from the industrial process. The cooling water is circulated through the system usually by one or more pumps. Some systems have water cooling towers which constitute an outlet for heat into the atmosphere. Inlet lines are provided for the dosing of chemicals such as anti-scalants and corrosion inhibitors. The systems are generally constructed with pipework and other surfaces which contain metals such as steels.

Corrosion is a concern in these cooling water systems, where many grades of steel are deployed in their construction. These are susceptible to the action of active chlorine or other halogens on fully immersed surfaces, on surfaces in the gas phase or at the interface between the aqueous phase and gas phase. Halogen-promoted electrochemical processes can also contribute to corrosion at the interface. Such corrosion is a particular problem in cooling water towers where both liquid and gas phases are present. In accordance with the present invention these problems are minimised. This is because the amounts of inorganic source of hypochlorite administered can be kept to a minimum owing to the presence of the antimicrobial compound.

The antimicrobial compound and the inorganic source of hypochlorite may be added to the cooling water as a solid, such as dry powder, or more preferably in a liquid form. Compounds may be dosed continuously or periodically.

The antimicrobial compound and the inorganic source of hypochlorite may be added as a unitary composition although more typically they are added separately or sequentially. They may be added simultaneously, either as a unitary composition or at the same time as separate components. Alternatively, they may be added sequentially as separate components. Addition as separate components may be made at the same location in the cooling water or at different locations. However the components are added, it is necessary for both to be administered to the cooling water for the combined effect to be realised.

The antimicrobial compound may be administered batchwise or continuously to the cooling water. Preferably it is dosed continuously to one or more dosing points in the system, in a manner so that the compound reaches all parts of the system which are prone to biofilm formation. The dosing points include the cooling tower basin just before the recirculating pump. It is preferable to avoid using the line through which other chemicals such as anti-scalants and corrosion inhibitors are dosed.

The inorganic source of hypochlorite may be administered batchwise or continuously to the process. Preferably it is dosed batchwise to one or more dosing points in the system, in a manner so that the compound reaches all parts of the system which are prone to biofilm formation. The dosing points include the cooling tower basin just before the recirculating pump. It is preferable to avoid using the line through which other chemicals such as anti-scalants and corrosion inhibitors are dosed.

Both components may be administered batchwise to the process, both components may be administered continuously to the process, or one component may be administered batchwise and the other continuously.

In general, the antimicrobial system according to the invention may be added to the cooling water in biostatic or biocidal amounts. Biostatic amount refers to an amount sufficient to at least prevent and/or inhibit the activity and/or growth of the microorganisms or the biofilm. Biocidal amount refers to more effective activity, such as to an amount capable of reducing the activity and/or growth of the microorganisms or the biofilm and/or killing most or all of the microorganisms present in the cooling water.

The inorganic source of hypochlorite may be administered to the water to provide an amount in the range of from 0.2 to 5 ppm, preferably 0.2 to 3 ppm, calculated as active chlorine and based on the volume of the water. Where the inorganic source of hypochlorite is administered batchwise to the water, this is advantageously to provide an amount of about 3 ppm for 1 to 2 hours per day, calculated as active chlorine and based on the volume of the water. Although this is not preferred, where the inorganic source of hypochlorite is administered continuously to the water, this is typically to provide an amount in the range of from 0.5 to 1 ppm calculated as active chlorine and based on the volume of the water. It is also possible, although not preferred, to administer amounts both batchwise and continuously. Typically, the amounts administered to the cooling water may be calculated, based on the volume of water in the system and, for continuous administration, the flow rate of hypochlorite into the system. The calculated amounts should correspond to measured amounts in the cooling water where the supply of water is clean. Where the cooling water supply contains substances, such as organic matter or chemical compounds, in quantities which will initially consume active chlorine from the hypochlorite, the calculated amounts will not correspond to measured amounts in the cooling water. Here higher amounts of the inorganic source of hypochlorite would need to be used to achieve the amounts calculated above as active chlorine, based on the volume of the water.

The amount of antimicrobial compound administered is in the range of from 0.01 to 1 ppm, preferably 0.02 to 0.5 ppm, more preferably 0.02 to 0.2 ppm, calculated as active compound and based on the volume of the water.

The invention further provides use of an antimicrobial system as defined above for treating industrial cooling water.

The invention further provides use of an antimicrobial system as defined above for reducing or preventing growth of microorganisms in industrial cooling water.

The present invention further provides use of an antimicrobial system as defined above for reducing or preventing biofilm formation and/or reducing or removing formed biofilm.

The present invention further provides a method for reducing or preventing growth of microorganisms, preferably bacteria, in industrial cooling water.

The present invention further provides a method for reducing or preventing biofilm formation and/or reducing or removing formed biofilm in industrial cooling water.

### DETAILED DESCRIPTION OF THE INVENTION

This invention will now be described in more detail, by way of example only, with reference to the accompanying FIGURE. This shows a bar chart demonstrating corrosion effects of chemical compounds used in the present invention.

The term “comprises” as used throughout the description and claims herein means “includes or consists of”. The term denotes the inclusion of at least the features following the term and does not exclude the inclusion of other features which have not been explicitly mentioned. The term may also denote an entity which consists only of the features following the term.

### EXPERIMENTAL PROCEDURES

### Materials and Methods

Authentic cooling water was obtained from a cooling water system in Germany.

Proteobacteria are commonly found from cooling waters (Water Research 159 (2019): 464-479). In the biofilm-experiments the test water was spiked with Pseudoxanthomonas taiwanensis, a biofilm-forming species belonging to the phylum Proteobacter.

Biofilm tests were done in simulated cooling water, SCW (prepared according to Marziya Rizvi et al., Nature Scientific Reports | (2021) 11:8353) using 96-microwell plate wells with peg lids (Thermo Fischer Scientific Inc., USA). Plates were incubated at 45° C. with a rotary shaking (150 rpm) providing high flow in each well.

3-[(4-methylphenyl)sulphonyl]-2-propenenitrile, hereinafter called Compound A; manufactured by Kemira; purity>98% E-isomer.

Sodium hypochlorite solution was obtained from Kemira Oyj (15% active ingredient). Since the active Chlorine decomposes over time, the amount of active Chlorine in the solution was measured prior to each experiment.

### Biofilm Tests

Wells of 96-microwell plates with peg-lids were filled with 10% authentic cooling water, 89% SCW and 1% of pure culture of Pseudoxanthomonas taiwanensis. Biofilm was grown at 45° C. with a rotary shaking (150 rpm) for 24 hours without addition of any chemical compound to be tested.

After 24 hours from starting the test, the wells were emptied and a fresh solution comprising 10% authentic cooling water, 89% SCW and 1% of pure culture of Pseudoxanthomonas taiwanensis with different amounts of chemical compounds to be tested were added and the original peg-lid was placed back in place. After an additional 24 hours the wells were emptied and the biofilm amount on the pegs was quantified.

### Quantification of Formed Biofilm

The amount of biofilm formed on the peg surfaces was quantified with a staining solution by adding 200 μl of 1% Crystal Violet (Merck Millipore KGaA, Germany) in methanol to each well in a clean 96-well plate and placing the biofilm-containing peg-lid on it. After 3 minutes the wells were emptied and the wells and pegs were rinsed 3 times with tap water. Finally the peg-lid was placed in a clean 96-well plate, the attached Crystal Violet was dissolved into ethanol and the absorbance at 595 nm was measured.

All parts per million (ppm) amounts given in Example 1 are as active ingredients. The Impact values are calculated as biofilm reduction percentages based on a comparison with no added chemicals. A positive value indicates a reduction in amount of biofilm whereas a negative value indicates an increase in the amount of biofilm.

### Example 1 (Anti-Biofilm Efficacy)

Table 1 shows the effect of sodium hypochlorite dosing in the presence and absence of Compound A on biofilms in authentic cooling water+SCW+Pseudoxanthomonas taiwanensis at 45° C. and 150 rpm (high mixing). Biofilm was stained and quantified by absorbance measurement. Dosages are given as active ingredients.

TABLE 1

| Sodium hypochlorite | Compound A | |
|---|---|---|
| ppm | ppm | Impact |
| 2 | | −30% |
| 4 | | −27% |
| 8 | | −25% |
| 12 | | −10% |
| 16 | | 6% |
| | 0.15 | −19% |
| | 0.30 | 2% |
| | 0.45 | 8% |
| 2 | 0.15 | 11% |
| 2 | 0.30 | 15% |
| 2 | 0.45 | 19% |

Table 1 demonstrates the ability of chlorine-containing biocide sodium hypochlorite to reduce and prevent biofilm formation of Pseudoxanthomonas taiwanensis, in the presence and absence of Compound A. The test conditions simulated industrial cooling water conditions. The chlorine-containing biocide sodium hypochlorite was ineffective on its own in reaching acceptable biofilm reduction efficacy. At levels of at least 12 ppm and below, amounts of biofilm continued to increase. Sodium hypochlorite on its own required a dosage of 16 ppm active compound to reach noticeable biofilm reduction efficacy. In contrast, in the presence of Compound A, a dose of only 2 ppm was required to provide significant biofilm reduction efficacy.

The results on anti-biofilm efficacy are surprising and important. At relatively low or moderate concentrations, a chlorine containing biocide compound, sodium hypochlorite, is ineffective against biofilms on its own in simulated cooling water. Should moderate or higher concentrations of hypochlorite be contemplated, it would be expected that the presence of the active halogen would have highly corrosive effects on industrial cooling water systems. At low concentrations, Compound A was also ineffective as an anti-biofilm agent. However, surprisingly, a combination of low concentration of sodium hypochlorite together with low concentrations of Compound A were effective against biofilm in simulated cooling water. Because only low amounts of active chlorine need be used, this is important in biofilm control in industrial cooling water systems because the levels of corrosion mediated by active chlorine will be significantly reduced. Hypochlorite is very effective against planktonic microorganisms even at low concentrations. Higher concentrations of hypochlorite previously required to be effective against biofilms are not needed in the presence of the antimicrobial compound, Compound A. Similar effects may be obtained from inorganic sources of hypochlorite other than sodium hypochlorite and benzenesulphonyl compounds of Formula (I) other than Compound A.

### Example 2 (Corrosion Testing)

In this example, anti-microbial compound and chlorine compound are subjected to corrosion testing.

Corrosion testing was performed following ASTM G31-72. Glass reactors of 2L in volume equipped with reflux condensers were used at atmospheric pressure. The reactors were immersed in a water bath at a temperature of 55° C. 1.35 L of SCW and 0.15 L of authentic cooling water was added to each reactor. Tests were performed in duplicate over a period of seven days with no stirring in the reactors. The tests were carried out with samples of Compound A, Sodium Hypochlorite and a reference containing SCW and authentic cooling water only. Stainless steel grade AISI 304 was used in the tests.

Before the test, coupons of the appropriate steel grade were ground to remove passivation film from the metal surface. After grinding, the coupon surfaces were cleaned with ethanol in an ultrasonic bath for 10 minutes and finally degreased and dried with acetone. The coupons were weighed and used on the same day.

After completion of the tests, the coupons were washed with a brush using washing detergent and hot water. They were then flushed with deionised water and pickled in 5% HCl in an ultrasonic bath for 10 minutes.

According to the test method, corrosion is calculated as mass loss of uniform corrosion.

For each chemical to be tested, a test coupon was placed in each reactor, half immersed in the liquid phase, half exposed to the gas phase. The chemicals to be tested were dosed in water to a final concentration of 0.08 ppm of Compound A and 4 ppm or 20 ppm of Sodium hypochlorite as active chlorine. Chemicals were added at the start and re-dosed during the study every second day. The aim of the dosages was to match realistic use conditions, i.e. shock dosages resulting in fluctuating levels of chemicals in the process water.

### Results

The results are shown in the FIGURE. This shows the mean of the results from duplicate reactors run for 7 days at 55° C.

In these tests Compound A and sodium hypochlorite were used at realistic dosage levels. These were 0.08 ppm of Compound A and either a high dose level of sodium hypochlorite (20 ppm) or a low dose level of sodium hypochlorite (4 ppm), expressed as total active chlorine. The high dose level simulates a level of hypochlorite required to be effective against microorganisms. The low dose level simulates a dose typically added to cooling water to provide a measured residual level around 3 ppm once part of the added dose is consumed by substances present in the cooling water. Coupons were half immersed to simulate conditions inside parts of an industrial cooling system.

In reactors treated with Compound A alone, the corrosion rates of the steel coupons were similarly as low as in reactors with cooling water only. In reactors treated with a combination of a low hypochlorite dose and Compound A showed similarly low corrosion rates compared with cooling water only. However, in the reactors treated with hypochlorite alone, the coupons showed nearly 3 times higher corrosion.

These results suggest that levels of an inorganic source of hypochlorite (such as sodium hypochlorite) and a benzenesulphonyl antimicrobial compound (such as Compound A) which are efficacious for biofilm treatment do not cause significant corrosion of the type of stainless steel used in industrial cooling water systems.

1. An antimicrobial system comprising (a) an antimicrobial compound according to Formula I 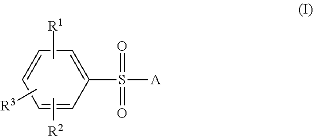
and
(b) an inorganic source of hypochlorite,
wherein the antimicrobial compound and the inorganic source of hypochlorite are separate components or comprise a unitary composition;
wherein R1, R2 and R3 independently represent a hydrogen atom; halogen atom; hydroxy group; amino group; alkylamino group, alkyl group, hydroxyalkyl group, acyl group, haloalkyl group or alkoxy group having 1 to 4 carbon atoms; or an acylamido group having 1 to 10 carbon atoms; and
A represents 2-thiazolamine; 2-propenenitrile; 2-propenoic acid; alkyl ester or hydroxyalkyl ester of 2-propenoic acid having 1 to 4 carbon atoms; or —CHCHCONR5R6 group, where R5 and R6 represent independently hydrogen atom, alkyl or hydroxyalkyl having 1 to 4 carbon atoms.

2. A system according to claim 1, wherein in Formula (I)
R1 represents methyl group; ethyl group; propyl group; butyl group; methoxy group; ethoxy group; propoxy group; isopropoxy group; n-butoxy group; or tertiary butoxy group; and
R2 and R3 represent independently hydrogen atom; methyl group; ethyl group; propyl group; butyl group; methoxy group; ethoxy group; propoxy group; isopropoxy group; n-butoxy group; tertiary butoxy group; and
A represents 2-propenenitrile.

3. A system according to claim 1, wherein in Formula (I)
R1 represents methyl group; ethyl group; propyl group; butyl group; methoxy group; ethoxy group; propoxy group; isopropoxy group; n-butoxy group; tertiary butoxy group; or amino group; and
R2 and R3 represent independently hydrogen atom; methyl group; ethyl group; propyl group; butyl group; methoxy group; ethoxy group; propoxy group; isopropoxy group; n-butoxy group; tertiary butoxy group; and
A represents a —CHCHCONR5R6 group, where R5 and R6 represent independently hydrogen atom; alkyl or hydroxyalkyl having 1 to 4 carbon atoms; preferably R5 and R6 representing hydrogen atoms.

4. A system according to claim 1, wherein the compound according to Formula (I) is selected from group consisting of 3-[(4-methylphenyl)sulphonyl]-2-propenenitrile, 3-phenylsulphonyl-2-propenenitrile, 3-[(4-fluorophenyl)sulphonyl]-2-propenenitrile, 3-[(4-trifluormethylphenyl)sulphonyl]-2-propenenitrile, 3-[(2,4-dimethylphenyl)sulphonyl]-2-propenenitrile, 3-[(3,4-dimethylphenyl)sulphonyl]2-propenenitrile, 3-(3,5-dimethylphenyl)sulphonyl-2-propenenitrile, 3-[(2,4, 6-trimethylphenyl)sulphonyl]-2-propenenitrile, 3-(4-methoxyphenyl)sulphonyl-2-propenenitrile, 3-[(4-methylphenyl)sulphonyl]prop-2-enamide, 3-[(4-methylphenyl)sulphonyl]prop-2-enoic acid, and any of their isomers.

5. A system according to claim 4, wherein the compound according to Formula (I) is selected from group consisting of 3-[(4-methylphenyl)sulphonyl]-2-propenenitrile, 3-phenylsulphonyl-2-propenenitrile, 3-[(4-trifluormethylphenyl)sulphonyl]-2-propenenitrile, 3-[(2,4,6-trimethylphenyl)sulphonyl]-2-propenenitrile, 3-(4-methoxyphenyl)sulphonyl-2-propenenitrile and 3-[(4-methylphenyl)sulphonyl]prop-2-enamide; and any of their isomers, wherein the compound is preferably 3-[(4-methylphenyl)sulphonyl]-2-propenenitrile.

6. A system according to claim 1, wherein the inorganic source of hypochlorite comprises sodium hypochlorite.

7. A method for treating industrial cooling water, which method comprises administering to the water (i) an amount of an antimicrobial compound according to Formula I 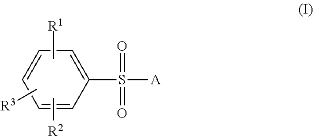
and
(ii) an amount of an inorganic source of hypochlorite;
wherein R1, R2 and R3 independently represent a hydrogen atom; halogen atom; hydroxy group; amino group; alkylamino group, alkyl group, hydroxyalkyl group, acyl group, haloalkyl group or alkoxy group having 1 to 4 carbon atoms; or an acylamido group having 1 to 10 carbon atoms; and
A represents 2-thiazolamine; 2-propenenitrile; 2-propenoic acid; alkyl ester or hydroxyalkyl ester of 2-propenoic acid having 1 to 4 carbon atoms; or —CHCHCONR5R6 group, where R5 and R6 represent independently hydrogen atom, alkyl or hydroxyalkyl having 1 to 4 carbon atoms.

8. A method according to claim 7, which comprises reducing or preventing growth of microorganisms, preferably bacteria.

9. A method according to claim 8, which comprises reducing or preventing biofilm formation and/or reducing or removing formed biofilm.

10. A method according to claim 8, wherein the microorganisms are bacteria belonging to phylum of Proteobacteria, such as Pseudoxanthomonas.

11. A method according to claim 7, wherein the temperature of the water is at least 30° C., preferably at least 40° C.

12. A method according to any of claim 7, wherein the amount of antimicrobial compound administered is in the range of from 0.01 to 1 ppm, preferably 0.02 to 0.5 ppm, more preferably 0.02 to 0.2 ppm, calculated as active compound and based on the volume of the water.

13. A method according to claim 7, wherein the antimicrobial compound is administered continuously to the water.

14. A method according to claim 7, wherein the amount of the inorganic source of hypochlorite administered to the water provides a range of from 0.2 to 5 ppm, preferably 0.2 to 3 ppm, calculated as active chlorine and based on the volume of the water.

15. A method according to claim 7, wherein the inorganic source of hypochlorite is administered batchwise to the water.

16. A method according to any of claim 15, wherein the inorganic source of hypochlorite is administered batchwise to the water to provide an amount of about 3 ppm for 1 to 2 hours per day, calculated as active chlorine and based on the volume of the water.

17. A method according to claim 7, wherein the antimicrobial compound and the inorganic source of hypochlorite are each added at a different location of the industrial cooling water.

18. A method according to claim 7, wherein:
(a) in Formula (I)
R1 represents methyl group; ethyl group; propyl group; butyl group; methoxy group; ethoxy group; propoxy group; isopropoxy group; n-butoxy group; or tertiary butoxy group; and
R2 and R3 represent independently hydrogen atom; methyl group; ethyl group; propyl group; butyl group; methoxy group; ethoxy group; propoxy group; isopropoxy group; n-butoxy group; tertiary butoxy group; and
A represents 2-propenenitrile; or
(b) in Formula (I)
R1 represents methyl group; ethyl group; propyl group; butyl group; methoxy group; ethoxy group; propoxy group; isopropoxy group; n-butoxy group; tertiary butoxy group; or amino group; and
R2 and R3 represent independently hydrogen atom; methyl group; ethyl group; propyl group; butyl group; methoxy group; ethoxy group; propoxy group; isopropoxy group; n-butoxy group; tertiary butoxy group; and
A represents a —CHCHCONR5R6 group, where R5 and R6 represent independently hydrogen atom; alkyl or hydroxyalkyl having 1 to 4 carbon atoms; preferably R5 and R6 representing hydrogen atoms.

19. A method according to claim 7, wherein the compound according to Formula (I) is selected from group consisting of 3-[(4-methylphenyl)sulphonyl]-2-propenenitrile, 3-phenylsulphonyl-2-propenenitrile, 3-[(4-fluorophenyl)sulphonyl]-2-propenenitrile, 3-[(4-trifluormethylphenyl)sulphonyl]-2-propenenitrile, 3-[(2,4-dimethylphenyl)sulphonyl]-2-propenenitrile, 3-[(3,4-dimethylphenyl)sulphonyl]2-propenenitrile, 3-(3,5-dimethylphenyl)sulphonyl-2-propenenitrile, 3-[(2,4, 6-trimethylphenyl)sulphonyl]-2-propenenitrile, 3-(4-methoxyphenyl)sulphonyl-2-propenenitrile, 3-[(4-methylphenyl)sulphonyl]prop-2-enamide, 3-[(4-methylphenyl)sulphonyl]prop-2-enoic acid, and any of their isomers.

20. A method according to claim 7, wherein the inorganic source of hypochlorite comprises sodium hypochlorite.

21. A method for treating industrial cooling water, which method comprises administering to the water: (i) an amount of an antimicrobial compound selected from the group consisting of 3-[(4-methylphenyl)sulphonyl]-2-propenenitrile, 3-phenylsulphonyl-2-propenenitrile, 3-[(4-trifluormethylphenyl)sulphonyl]-2-propenenitrile, 3-[(2,4, 6-trimethylphenyl)sulphonyl]-2-propenenitrile, 3-(4-methoxyphenyl)sulphonyl-2-propenenitrile and 3-[(4-methylphenyl)sulphonyl]prop-2-enamide; and any of their isomers; and (ii) an amount of sodium hypochlorite.
